(19) United States
(12) Patent Application Publication
(10) Pub. No.: US 2026/0347126 A1
(43) Pub. Date: Nov. 5, 2026

(54) A Device for Transporting an Object

(71) Applicant: OPTIMUS SORTER HOLDING B.V., Beuningen (NL)

(72) Inventors: Albertus Cornelis Hendriks, Beuningen (NL); Ronald Michael Celeste, Augsburg (DE)

(73) Assignee: OPTIMUS SORTER HOLDING B.V., Beuningen (NL)

(21) Appl. No.: 19/107,716

(22) PCT Filed: Aug. 29, 2023
(86) PCT No.: PCT/NL2023/050440

§ 371 Date: Feb. 28, 2025

(30) Foreign Application Priority Data
Aug. 30, 2022 (NL) 2032901

(51) Int. Cl. B65G 47/46; B65G 43/08; B65G 47/82

(52) U.S. Cl. CPC B65G 47/46; B65G 43/08; B65G 47/82

(57) ABSTRACT

Please cancel the entire currently pending Abstract and replace it with the following A device is configured to transport an object, the device including at least one transport unit that is guidable along a transport path by a guide means. Each transport unit includes an object support surface and an object pusher that is movable along the support surface. The object pusher also includes an operating part. The transport system includes a guide surface that extends at an angle relative to the pusher, and which is arranged to engage with the operating part for moving the object pusher from a first to a second position. The operating part includes a first operating part that is fixedly mounted to the object pusher, and a second operating part that is arranged to be engaged by the guide surfaces and which is releasably connected to the first operating part via a magnetic force.

### CROSS-REFERENCES TO RELATED APPLICATIONS

This Non-Provisional US Patent Application claims the benefit of and priority to PCT Application Serial No. PCT/NL2023/050440, filed Aug. 29, 2023, entitled “A Device for Transporting an Object,” which claims the benefit of and priority to Netherlands Patent Application Serial No. NL 2032901, filed Aug. 30, 2022, entitled “A Device for Transporting an Object,” the entire contents of both applications of which are hereby incorporated herein by reference.

### BACKGROUND

Devices for transporting objects have been known from EP 1 972 579 A1 and EP 3 693 301 A1, and may be used for sorters where packages may need to be delivered at a multitude of exits (e.g. chutes or further conveyors). The device may be a so called horizontal sorter, wherein the transport path follows a curved path seen from above, or a so called vertical sorter, wherein the transport path for the objects is straight, but the return transport path for the unloaded objects transport units is vertically below the transport path for transport units loaded with the objects. It is a problem that the device sometimes becomes blocked, for instance when the object is blocked from leaving the object transport unit by another object at the delivery exit. The forced movement of the object pusher may then damage parts of the device, such as the pusher arm, the object or the driving system of the conveyor.

The object of the present invention is to reduce the above problem.

### SUMMARY

The present invention relates to a device for transporting an object, provided with at least one object transport unit for carrying an object, guidable along a transport path (B) by guide means, wherein each transport unit is provided with an object support surface (V, 121) and with an object pusher movable along this support surface (V) in a pusher direction (X) substantially perpendicular to the transport path (B) between a first and second position for pushing an object located, during use, on this surface (V) from this surface (V), said object pusher being provided with an operating part;

wherein the transport system is provided with object pusher moving means comprising a guide surface extending at an angle (a, B) relative to the pusher direction (X) and which is arranged to engage the operating part for moving the object pusher from the first position to the second position, under the influence of a movement of the respective object transport unit along the transport path.

To this end, a device according to the preamble is characterized in that said operating part comprises a first operating part which is fixedly mounted to the object pusher, and a second operating part which is arranged to be engaged by said guide surfaces and which is releasably connected to the first operating part by means of a magnetic force.

Thereby, the connection between the two operation parts will be lost when the engagement force exceeds said magnetic force, such that damage of the device or the object is prevented. The device will then be stopped for solving the problem and reconnecting the second operating part to the first operating part. The magnitude of said magnetic force can be calculated and set very precisely so that a reliable damage prevention mechanism is achieved and at the same time unnecessary downtime of the device is avoided.

According to a preferred embodiment, the second operating part engages a guide which extends in horizontal direction such that it can move along said guide away from the first operating part.

Preferably, said guide is mounted to the bottom side of the transport unit.

According to a favourable embodiment, said guide extends in the pusher direction (X).

According to a favourable embodiment, said guide is engaged by said first operating part such that it can move along said guide for moving said object pusher in said pusher direction (X).

According to an embodiment, at least one of the first operating part and the second operating part comprises a permanent magnet, and the other operating part comprises a permanent magnet or a magnetic material.

According to an embodiment, both operating parts (234a, 234b; 1141, 1142) comprise permanent magnets.

According to an alternative embodiment, the first operating part comprises an electromagnet and the second operating part comprises a magnetic material.

According to a preferred embodiment, said electromagnet is powered by a variable current source, such that the magnetic force can be set to a desired value.

Preferably, said magnetic force is dynamically set in dependence on an actual speed of the object transport unit or an actual weight of the object carried on the transport unit, or a combination thereof.

Preferably, the second operating part comprises a base comprising said magnet or said magnetic material and a roller rotatably mounted on said base.

According to an embodiment, the device is a sorter.

According to an embodiment, the object transport unit is a tray provided with leading and trailing upright side walls.

### BRIEF DESCRIPTION OF THE DRAWINGS

The present invention will now be illustrated with reference to the drawing where

FIG. 1 shows a perspective view on a sorter;

FIG. 2A and FIG. 2B show perspective views of a tray respectively;

FIG. 3A through FIG. 3C respectively show a top view, a side view and a front view on the tray of FIG. 2A;

FIG. 4A and FIG. 4B show a cross-sectional view through the tray of FIG. 3B and a detail thereof;

FIG. 5 schematically shows a top plan view of a part of the sorter;

FIG. 6 schematically shows a side view of the part represented in FIG. 5;

FIGS. 7A, 7B, 7C show three successive positions of the tray;

FIG. 8 schematically shows a top plan view of alternative embodiments of a part of the sorter;

FIG. 9A through FIG. 9C respectively show a partial perspective view, top view, side view and front view of a first alternative embodiment of the tray in a first state;

FIG. 10A through FIG. 10C respectively show a partial perspective view, top view, side view and front view on the first alternative embodiment of the tray in a second state;

FIG. 11A through FIG. 11C respectively show a partial perspective view, side view and bottom view of a second alternative embodiment of the tray in a first state; and

FIG. 12A through FIG. 12C respectively show a partial perspective view, bottom view, side view and bottom view on the second alternative embodiment of the tray in a second state.

### DETAILED DESCRIPTION

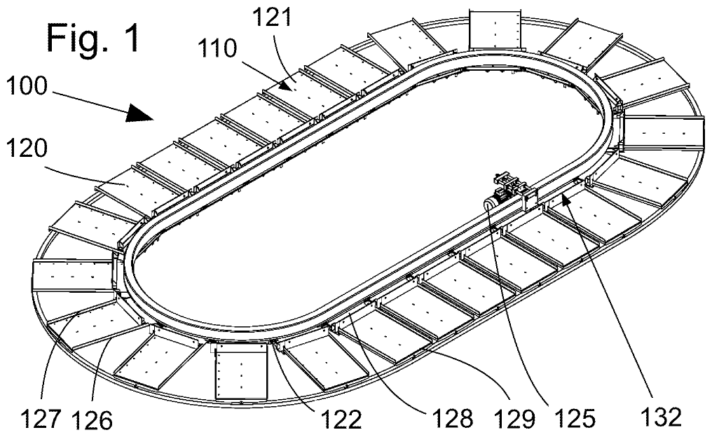

FIG. 1 shows a perspective view on a device 100, more specifically a sorter 100. It comprises a conveyor 110, said conveyor comprising a plurality of trays 120 providing a support surface 121 for an object (not shown) to be transported and sorted. The trays comprise conveyor bars 122, and the conveyor bars 122 of adjacent trays 120 are hingedly linked to form an endless chain 132. This chain 132 is driven using an actuator 125, typically an electric motor 125 to move the trays 120 in a continuous loop. A sorter 100 as described above is generally known in the art.

For the purpose of the description of the present invention, the trays 120 comprise a leading side 126, and a trailing side 127, where in FIG. 1 the conveyor 110 is assumed to run counter-clockwise.

At the side of the conveyor bar is designated the rear side 128 and its opposite side is designated the front side 129.

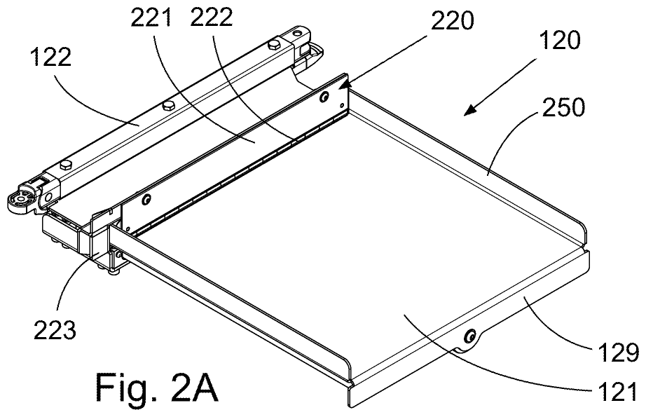

FIG. 2A and FIG. 2B show a perspective top view and a perspective bottom view of a tray 120 respectively. The tray comprises a moveable barrier 220 (pusher plate 220) comprising a barrier body 221 and at a lower edge there of a multitude of barrier elements 222 in contact with the support surface 121 of the tray 120.

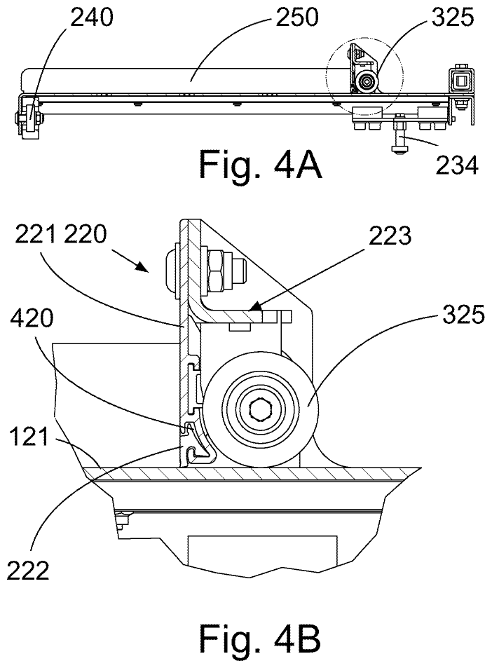

The tray 120 comprises a guide 230 for the pusher plate 220 so as to allow it to move from a position relatively close to the rear side 128 to the front side 129 and back. To this end, the barrier 220 comprises a frame 223 engaging the guide 230 and provided with an operating part 234 in the form of a protruding pin 234. When the tray 120 is moved, the device 100 may engage the pin 234 so as to push it sideways. To that end the device 100 is provided with object pusher moving means 11, as disclosed in EP 1 972 579 A1, which is incorporated herein by reference, and described below with reference to FIGS. 5-9 .

The tray 120 comprises a wheel 240 for running along a track of the conveyor and upright sidewalls 250 to keep the object on the support surface 121 of the tray 120.

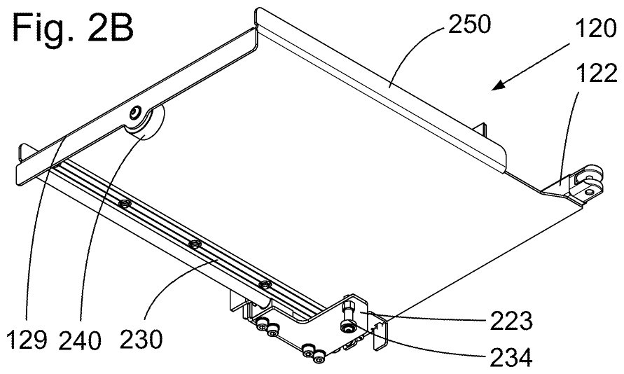

FIG. 3A through FIG. 3C respectively show a top view, a side view and a front view on the tray of FIG. 2A.

The pusher plate 220 comprises a wheel 325 that allows it to move with little friction across the support surface 121. In the embodiment discussed here, it also determines the distance of the barrier body 221 to the support surface 121.

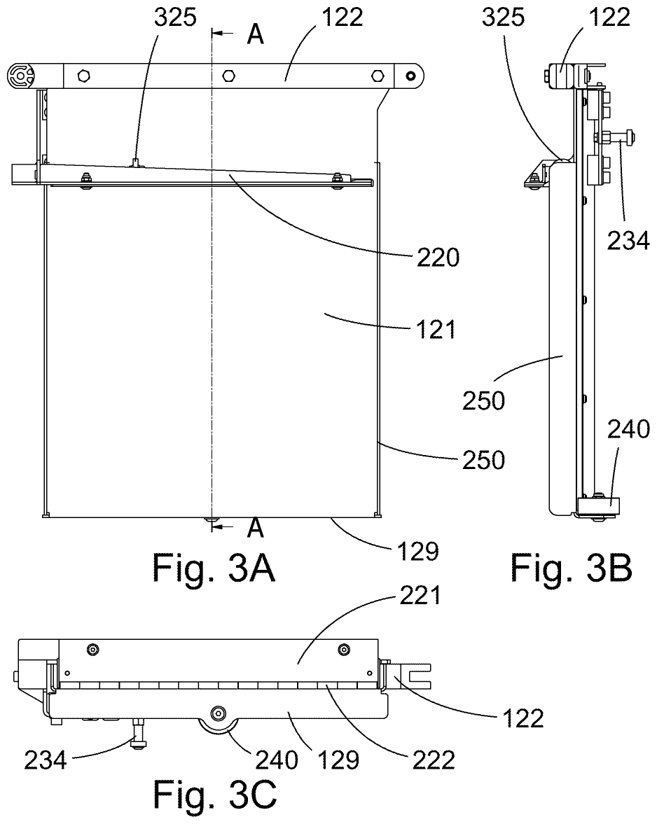

FIG. 4A and FIG. 4B show a cross-sectional view through the tray of FIG. 3B and a detail thereof.

The pusher plate 220 comprises a slot 420 accommodating the barrier element 222 that in this embodiment is V-shaped. The slot 420 is oversized in that it allows tilting of the barrier element 222 and an up and down movement. This allows the barrier element 222 to follow the support surface 121 of the tray 120, and reduces the risk that any object or part thereof gets trapped between the barrier 220 and the support surface 121.

As shown in FIGS. 5-8 the pusher plate moving means are in particular provided with engaging elements 11a that can be brought to a first (high) position in a path of the operating part 234, here in the form of a wheel 7, for engaging this operating part 234, and to a second (low) position for allowing this operating part 234 to pass, during movement along the transport path of the respective tray 120. The pusher plate moving means comprise guide surfaces which engage the operating part 234, wherein each guide surface includes a given angle to a virtual transverse plane of the path of the tray 120, which leads to a given speed of movement of the pusher plate 220 at a given path speed of the tray 120.

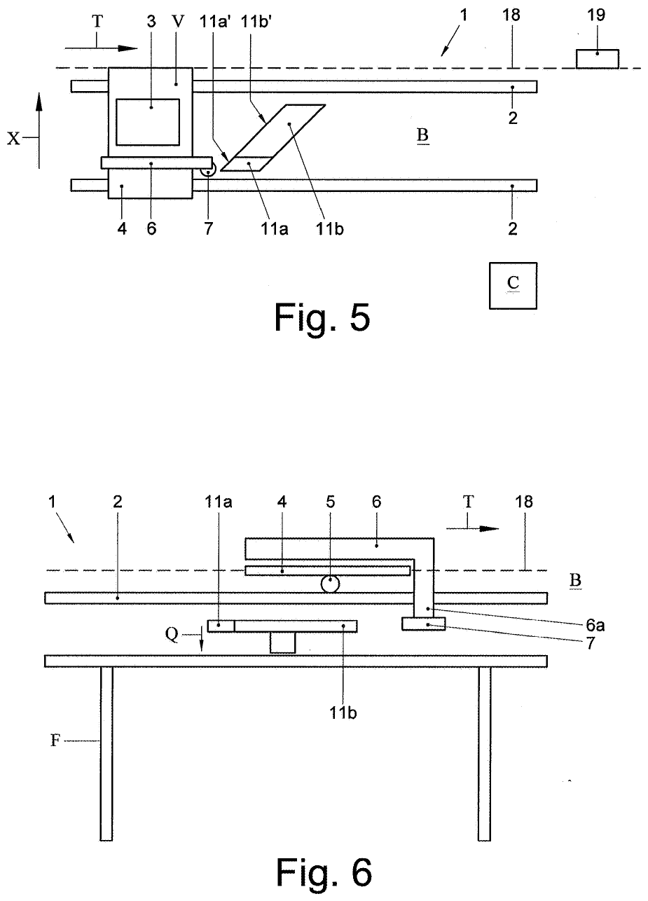

FIGS. 5-8 schematically show a sorter 1, which is provided with trays 4, guidable by the track 2 along the transport path. A support construction F is provided (see FIG. 6) for supporting the system. The track 2 is designed for guiding each tray 4 parallel to the transport path B, in a transport direction T. Each tray 4 is provided with a guide wheel 5 for running along the track 2. A drive 19 is provided for advancing the chain 18 extending along the path B, while each tray 4 is coupled to the chain 18 so as to be pulled along the path B by this element. An object 3 is carried by the tray 4, while the unit 4 is moved by the drive 19, via the drive element 18, along its path B.

More in particular, as shown schematically in FIGS. 5-8, the transport system 1 is provided with pusher plate moving means 11 which are designed for moving the pusher plate 6 from the first position to the second position, relative to the respective tray 4, under the influence of a movement of the respective tray 4 along the transport path (at least, along the respective path section where these moving means 11 are provided). In other words: a movement of the respective tray 4 along the transport path can automatically lead to (i.e. can be converted into) a movement of the pusher plate 6. In particular each pusher plate 6 is movable from its first position to its second position under the influence of an action force applied by the drive 19. Preferably, the pusher plate moving means are arranged below the path of the tray.

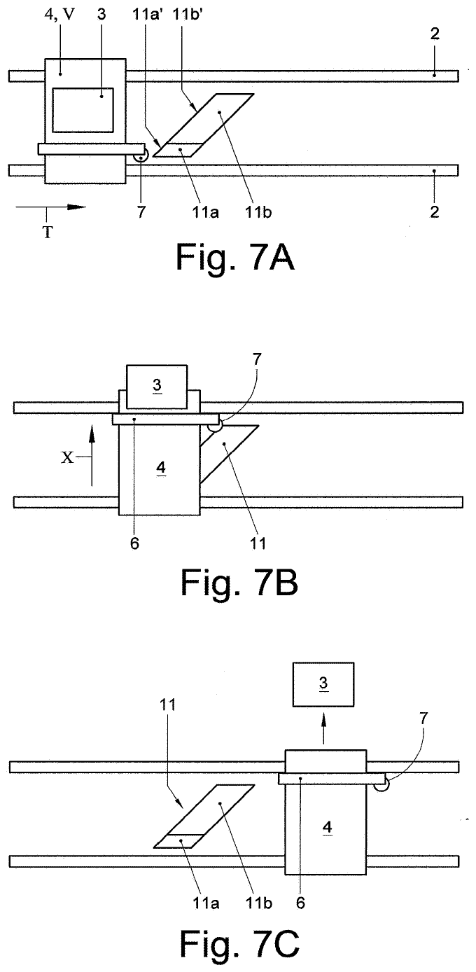

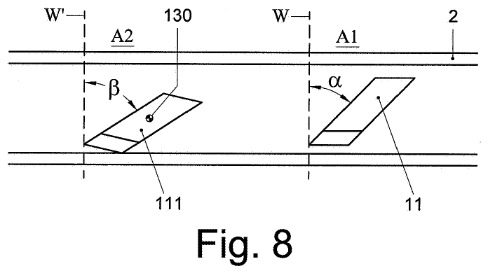

The pusher plate moving means 11 are further designed for mechanically cooperating with the operating part 7 of the pusher plate 6 of an tray 4 moving along or adjacent those moving means 11 such that this cooperation leads to the movement mentioned of the pusher plate 6. The operating part 7 is engageable by the pusher plate moving means 11, and is movable from a first to a second operating part position for moving the pusher plate, during use, from the first to the second pusher plate position. A first position of the pusher plate operating part 7 is represented in FIGS. 7A, 8A-8C. FIGS. 7B and 7C show a second position of this operating part. The first operating part position is for instance on or near a first longitudinal side of the tray 4 (as in FIG. 7A), and the second operating part position is on or adjacent a second longitudinal side of this unit 4 (as in FIG. 7B) .

The pusher plate moving means 11 may be provided with first engaging elements 11a that can be brought to a first position in a path of the operating part 7 for engaging this operating part 7, and to a second position for allowing the operating part 7 to pass, during movement along the transport path of the respective tray 4. FIGS. 7A-7C show the operation of the exemplary embodiment, when these first engaging elements 11a are in the first position, and FIGS. 8A-8C the operation with the first engaging means 11a in the second position. A movement of a first engaging element 11a is schematically indicated with an arrow Q in FIG. 6. Movement of the first engaging element 11a can for instance be effected under the influence of a suitable actuator, for instance servo, linear motor, an electromagnetic actuator, pneumatic and/or hydraulic actuator means and/or the like. Further, each first engaging element 11a is associated with a second engaging element 11b such that during movement of the tray, a first engaging element 11a located in its first position can move an operating part 7 from the first operating part position to a respective second engaging element 11b, and the second engaging element can take over the operating part 7 from the first engaging element 11a and thereupon move to the second operating part position. These engaging elements 11a, 11b can be designed in different manners, and comprise guide plates, rods, push plates or suitable profiles, or be constructed otherwise, which will be clear to the skilled person.

The guide surfaces 11a′, 11b′ of the moving means extend in a substantially slanting manner, at an angle relative to the transport direction T. Each guide surface 11 a′, 11b′can extend for instance along a straight line, viewed in top plan view (see FIGS. 5, 7-8) , or along a curve, or be provided with straight and curved parts. Thus, an operating part 7, upon cooperation with the engaging means 11, can travel for instance a straight line, viewed in top plan view, or a curve, or a combination thereof, under the influence of the movement of the tray 4. It may for instance be advantageous if the pusher plate moving means are designed for gradually accelerating and/or decelerating the pusher plate, under the influence of a movement of the respective tray 4 along the transport path. This can be achieved relatively simply when at least one or each lateral end part of a guide surface 11a′, 11b′ is provided with a suitable curve.

The guide surfaces 11a′, 11b′ preferably extend substantially in vertical direction. When a first engaging element 11a is in its first position, the guide surface 11a′ of that engaging element 11a′ substantially links up without clearance with the guide surface 11b′ of the associated second engaging element (see FIGS. 5, 6, 7A-7C) . When a first engaging element 11a is in its second position, the guide surface 11a′ of this engaging element 11a′ is at a distance from the guide surface 11b′ of the associated second engaging element.

FIGS. 5-8 show a use of the transport system, wherein for instance an object 3 is carried by the tray 4, while the unit 4 is moved by the drive 19, via the drive element 18, along its path B.

Depending on the use, the object may have been brought onto the tray manually and/or by suitable transport means (not represented), which will be clear to the skilled person.

During use, the tray 4 can approach a path section that is provided with an engaging means assembly 11a, 11b, if the tray 4 travels in the transport direction T along the path B. A force for moving the tray is generated by the drive 19.

If it is desired to remove the object 3 from the tray 4 in the area at the respective path section that is associated with the engaging element assembly 11a, 11b, the first engaging element 11a of this assembly can simply be brought to the respective first position. As a result, the first engaging element 11a can engage the approaching operating part 7 of the pusher plate 6 of the approaching tray 4. FIGS. 6 and 7A show in particular the associated, raised first position of the first engaging element 11a.

With a further movement along the respective path section, the tray approaches the first engaging element 11a, and moves there along. Here, the first, raised engaging element 11a will automatically engage the operating part 7 of the pusher plate 6 and thus move the pusher plate from the first pusher plate position in the direction of the second pusher plate position. Here, first, the operating part 7 rolls over the guide surface 11a′ of the first engaging element, at least is pulled there along, and thereupon rolls over-i.e. is pulled along-the guide surface 11b′ of the adjacent second engaging element 11b (see FIG. 7B) . Here, guiding of the operating part 7 is automatically taken over by the second engaging element 11b of the first engaging element.

As the operating part 7 is pulled along the guide surfaces 11′, the pusher plate 6 coupled to the operating part 7 is moved from its first position to the second position, and the object 3 is slid from the support surface V by the pusher plate 6. Hence, movement of the pusher plate 6 is the direct result of the movement of the respective tray 4. The object slid from the support surface can be received by receiving means (not represented), for instance discharge transport means, a discharge channel, sorting means, storing means, an other transport system 1 and/or other object receiving means.

As schematically represented in FIG. 8 the pusher plate moving means 11, with guide surfaces 11′, may include a relatively small angle a to a virtual transverse plane W of the path, which may lead to a relatively high speed of movement of the pusher plate at a given path speed of the tray 4, or the pusher plate moving means 111, with guide surfaces 111′, may enclose a relatively large second angle β (β>α) to a virtual transverse plane W′ of the path, which may lead to a relatively low speed of movement of the pusher plate at the given path speed of the tray 4. It is further an option that the pusher plate moving means be adjustable for setting an pusher plate speed. The pusher plate speed may therefore be variable. Setting the pusher plate moving means can be done in various manners. The pusher plate moving means 111 can for instance be pivotal about a virtual pivot 130 such that the angle β to the virtual transverse plane W′ of the path can be set. Such a setting can for instance be carried out manually. Alternatively, drive means can for instance be provided for automatically adjusting the position of the pusher plate moving means 111, for instance under the influence of a control C.

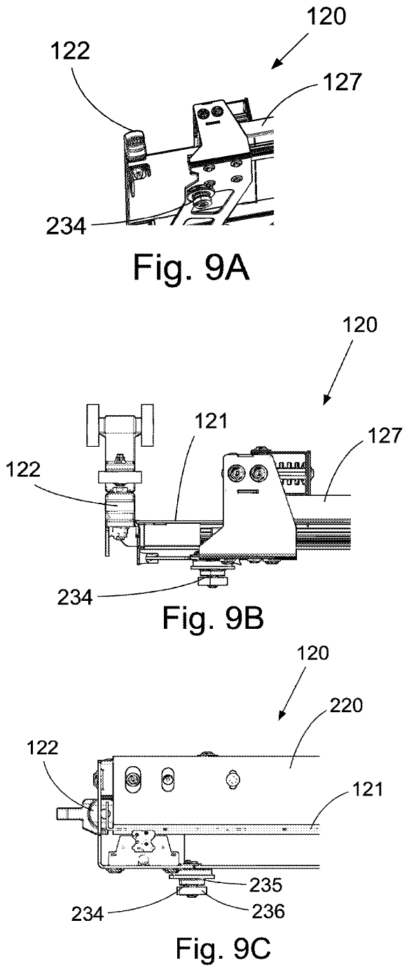

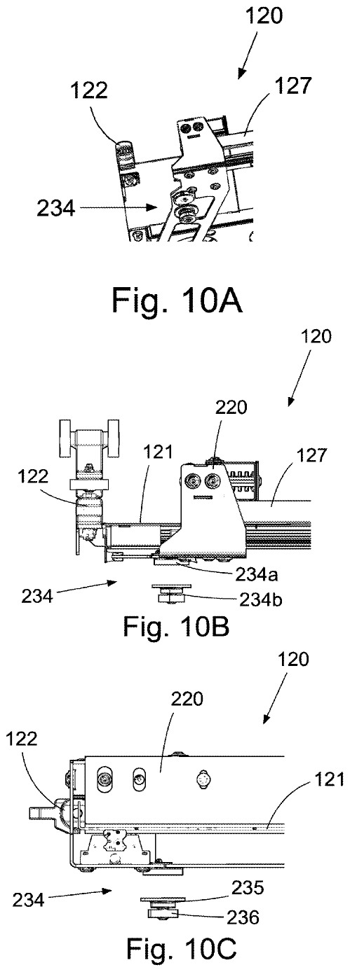

According to FIGS. 9A-9C and 10A-10C the operating part 234 comprises two separate parts 234a, 234b, which are magnetically connected to each other. The first operating part 234a is a mounting part 234a, which is fixedly mounted to the tray 120. The mounting part 234a may comprise a magnet or be made of magnetic material. The second operating part 234b is a downwardly protruding part 234b, which is to be engaged by the guide surfaces 11a′, 11b′of the engaging elements 11a, 11b (see FIGS. 5-8), and which is releasably connected to the first operating part 234a by means of a magnetic force. In FIGS. 10A-10C the second operating part 234b is shown in the disconnected state.

The second operating part 234b comprises a base 235 comprising a magnet or be made of magnetic material, and a roller 236 rotatably mounted on said base 235, so that the roller 235 can roll over the guide surfaces 11a′, 11b′.

The magnetic force between the parts 234a, 234b can be chosen such that, when the guide surfaces 11a′, 11b′ engage the second operating part 234b the engagement force is more than it should be, based on a (maximum or actual) speed of the conveyor and a (maximum or actual) weight of the object on the tray 121, the connection between the two parts 234a, 234b will be lost and the second operating part 234b is disconnected.

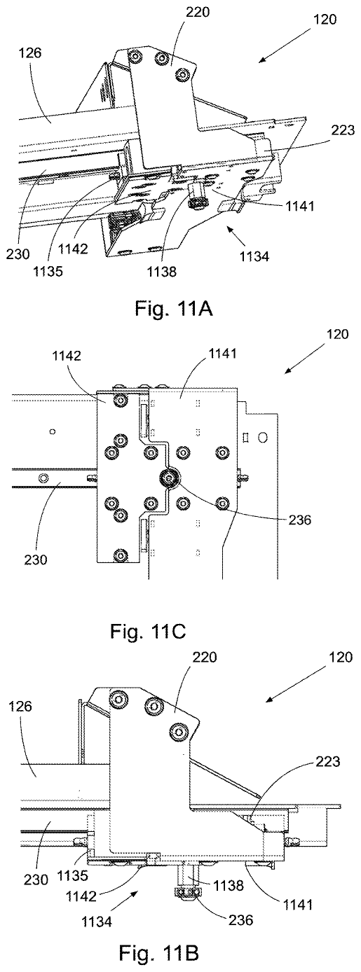

According to FIGS. 11A-C and 12A-C the operating part 1134 comprises two separate parts 1141, 1142, which are magnetically connected to each other.

The first operating part 1141 is part of the frame 223 engaging the guide 230 and which is fixedly connected to the pusher plate 220. The first operating part 1141 may comprise a magnet 1139 or a member 1139 made of magnetic material.

The second operating part 1142 comprises a base frame 1135 comprising a magnet or magnetic material 1137, and a downwardly protruding part 1138 with a roller 236 rotatably mounted on said base 1135, so that the roller 236 can roll over the guide surfaces 11a′, 11b′. The base frame 1135 engages the guide 230 and can move there along.

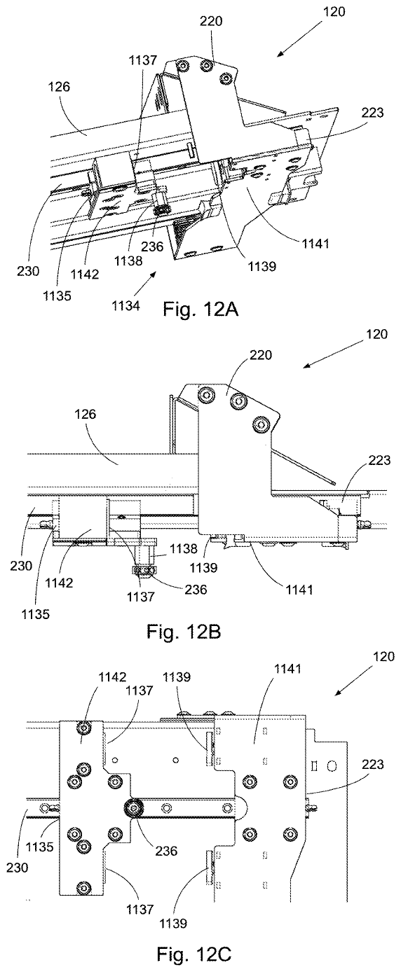

In FIGS. 12A-12C the second operating part 1142 is shown in the disconnected state, wherein the second operating part 1142 has traveled away from the first operating part 1141 along the guide 340.

The magnetic force between the parts 1141, 1142 can be chosen such that, when the guide surfaces 11a′, 11b′ engage the second operating part 1142 the engagement force is more than it should be, based on a (maximum or actual) speed of the conveyor and a (maximum or actual) weight of the object on the tray 121, the connection between the two parts 1141, 1142 will be lost and the second operating part 1142 is disconnected.

The second operating part 1142 can easily be reconnected with the first operating part 1141 by sliding it back along the guide 230. This can be achieved automatically by means of an engaging element (not shown) at an appropriate location along the conveyor, with a similar mechanism as the pusher plate moving means 11, with a guide surface that engages the roller 236 to push the pusher plate 220 or, in case it was disengaged, only the second operating part 1142 back to the original position.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein.

An element is to be considered equivalent to an element specified in the claims at least if said element performs substantially the same function in substantially the same way to yield substantially the same result as the element specified in the claims.

1. A device for transporting an object, provided with at least one object transport unit for carrying an object, guidable along a transport path by guide means,
wherein each transport unit is provided with an object support surface and with an object pusher movable along this support surface in a pusher direction substantially perpendicular to the transport path between a first and second position for pushing an object located, during use, on this surface from this surface, said object pusher being provided with an operating part;
wherein the transport system is provided with object pusher moving means comprising a guide surface extending at an angle relative to the pusher direction and which is arranged to engage the operating part for moving the object pusher from the first position to the second position, under the influence of a movement of the respective object transport unit along the transport path; characterized in that said operating part comprises a first operating part which is fixedly mounted to the object pusher and a second operating part which is arranged to be engaged by said guide surfaces and which is releasably connected to the first operating part by means of a magnetic force.

2. The device of claim 1, wherein the second operating part engages a guide which extends in horizontal direction such that it can move along said guide away from the first operating part.

3. The device of claim 2, wherein said guide (230) is mounted to the bottom side of the transport unit.

4. The device of claim 3, wherein said guide extends in the pusher direction.

5. The device of claim 4, wherein said guide is engaged by said first operating part such that it can move along said guide for moving said object pusher in said pusher direction.

6. The device of claim 5, wherein at least one of the first operating part and the second operating part comprises a permanent magnet, and the other operating part comprises a permanent magnet or a magnetic material.

7. The device of claim 6, wherein both operating parts comprise permanent magnets.

8. The device of claim 5, wherein the first operating part comprises an electromagnet and the second operating part comprises a magnetic material.

9. The device claim 8, wherein said electromagnet is powered by a variable current source, such that the magnetic force can be set to a desired value.

10. The device of claim 9, wherein said magnetic force is dynamically set in dependence on an actual speed of the object transport unit (4, 110) or an actual weight of the object (3) carried on the transport unit (4, 110), or a combination thereof.

11. The device of claim 10, wherein the second operating part comprises a base comprising said magnet or said magnetic material and a roller rotatably mounted on said base.

12. The device of claim 11, wherein the device is a sorter.

13. The device of claim 12, wherein the object transport unit is a tray provided with leading and trailing upright side walls.
